(19) United States
(12) Patent Application Publication
(10) Pub. No.: US 2004/0149806 A1
(43) Pub. Date: Aug. 5, 2004

(54) Explosively bonded composite structures and method of production thereof

(76) Inventor: Roy Hardwick, Troon (GB)

Correspondence Address: MANELLI DENISON & SELTER, 2000 M STREET NW SUITE 700, WASHINGTON, DC, 20036-3307, US

(21) Appl. No.: 10/747,118

(22) Filed: Dec. 30, 2003

(30) Foreign Application Priority Data
Jan. 2, 2003 (GB) GB 03000.14.8

(51) Int. Cl. B23K 20/08

(52) U.S. Cl. 228/107

(57) ABSTRACT

A process for the manufacture of an explosively-bonded composite structure comprising a substrate, a metallic cladder and an intervening interlayer between the substrate and the cladder; the cladder and the interlayer having a waveless interface therebetween, the process comprising (A) forming a non-bonded composite structure comprising in combination, (a) a substrate having a first side; (b) an interlayer of a material compatible with the substrate, and having (i) a thickness T1; (ii) a mass M1; (iii) a first side adjacent to the substrate at a distance D1, therefrom; and (iv) a second side; (c) a cladder having (i) a thickness TC; (ii) a mass MC; (iii) a first side adjacent to the second side of the interlayer at a distance D2 therefrom; and (iv) a second side; and (d) an explosive mixture adjacent the second side of the cladder; and wherein D1 is equal to or less than 2T1; D2 is equal to or less than TC; and MC is equal to or greater than M1; and (B) detonating said explosive mixture. The method produces one or more totally flat interfaces, which avoids the formation of deleterious waves and the associated inherent problems of cracking and incorporated intermetallics. The method also allows of the use of thin interlayers, which is of value when such interlayer materials are expensive.

### FIELD OF THE INVENTION

This invention relates to a method of explosively bonded composite structures, which method produces one or more totally flat interfaces, which avoids the formation of deleterious waves and the associated inherent problems of cracking and incorporated intermetallics. The method also allows of the use of thin interlayers, which is of value when such interlayer materials are expensive.

### BACKGROUND OF THE INVENTION

Explosive bonding was first used commercially in the late 1950's. The basic method is well known and, in its simplest form consists of placing an upper plate or sheet component which is to be clad (the cladder, or flyer plate) over the underlying substrate (the base) material plate, with an intervening gap between them. A layer of explosive is placed upon the upper surface of the flyer plate and detonated. A detonation front is created, passes through the explosive and, directly beneath the detonation front, progressing over the area of the assembly, the flyer plate is deformed at an angle known as “the dynamic angle”. The flyer plate is projected over the intervening gap to collide with the substrate material, also at an angle, termed the “collision angle”, which is identical to the dynamic angle when the substrate and cladder components lie parallel to each other. Thus, a collision front is formed at the interface which progresses over the area being bonded and, because of the dissipation of the kinetic energy of the flyer plate, heat and pressure at this collision front cause the two colliding surfaces to behave as inviscid fluids, which results in a small amount of material from each surface being removed and projected forward as a jet of material. This jet contains the surface contaminants and oxides previously present on these surfaces. Behind the collision front are two clean, unoxidized mating surfaces, under pressure, which produces a form of pressure bond maintained by electron sharing of the adjacent atoms of the two surfaces at their interface.

Over the many years that explosive bonding has been used in this manner for the manufacture of clad plate, the bonded interface has been characterized by a wavy topography. The interfacial waves are associated with metal flow at the interface during the bonding process, and are the result of several parameters which influence the topography of the interface. The principal parameter controlling the shape of the waves is the collision angle at which the two surfaces are brought together. This angle, itself, is determined primarily by the detonation velocity of the explosive. The higher the detonation velocity of the explosive, the lower is the collision angle and the more turbulent is the metal flow. The amplitude of the waves is also a feature affected by the explosive loading insofar as the loading affects the kinetic energy available on the collision of the mating surfaces. Another important feature affecting the level of kinetic energy is the mass of the flyer plate. The thicker is the flyer plate which is projected at the velocity engendered by the required explosive loading, the larger will be the waves at the interface.

If the bonded components are of identical material, the interfacial waves are sinusoidal in shape and have associated wave vortices which are minimal in size. Within the vortices are small proportions of molten metal resulting from adiabatic pressure within the vortices. This molten material is of the same composition as the parent material and has no significant deleterious effect.

However, when dissimilar metals are bonded as in, typical, commercial cladding operations, for any given bonded metal combination, a lower collision angle will produce a waveform characterized by an overturning wave crest producing an associated vortex which, because of adiabatic pressure within the vortex, now contains a molten alloy of the two surface materials. In some instances, the particular material combination which is being bonded produces one or more phases of an alloy in the form of a brittle intermetallic, which substantially weakens the resulting bond. A higher collision angle in that same metal combination will produce a more undulatory wave form with correspondingly smaller vortices, which diminish their associated problems. However, the component vector of force at the interface now occurs at a higher angle, resulting in higher shear loadings which can produce shear cracks in less ductile cladder materials, such as, duplex structured stainless steels, some titanium grades, high nickel alloy steels and aluminum bronzes. These shear cracks emanate from the wave crests towards the surface and often reach that surface. Even when the crack does not reach the surface during the bonding operation, this incipient form of crack will often propagate during any subsequent fabrication of the clad plate, or in the service environment in which the clad operates, giving rise to subsequent failure. Even in the absence of any crack, adiabatic shear bands can be present in the same location at the tops of the waves emanating towards the surface, and cracking can subsequently develop within these shear bands.

If the collision angle is further increased, the wave form will ultimately disappear, giving rise to an ideal flat interface devoid of any intermetallics, and removing any risk of shear cracks or the adiabatic shear bands which are an incipient form of these cracks. The actual detonation velocity at which this transition from wavy to waveless interface occurs will vary with the specific metal combination to be bonded. This is due to other salient factors, such as, the differential in the yield strength of the chosen materials and/or the hardness of the materials, but in general, a velocity of 1800 m/sec. approximates the boundary where this transition occurs. U.S. Pat. No. 6,554,927—Sigmabond Technologies Corporation, issued Apr. 29, 2003, describes the use of a composition and form of an explosive mixture which detonates at a velocity of less than 1800 m/sec., which is sufficiently low to engender the high collision angles and give rise to this type of waveless interface, which avoids the associated disadvantages of the wavy interface.

One disadvantage of conventional higher velocity powder explosive mixtures normally used in the bonding or cladding of metals, is that the detonation velocity is affected not only by the explosive composition, but also by its depth. The greater is the amount of explosive required for any given thickness of cladder, the greater will be the depth of the explosive layer, which gives rise to an increase in the density of the explosive mixture because of its added weight and associated compaction. This increased density will give rise to increased detonation velocity because the detonation velocity of any specific type of explosive is related to its density, with an increase in density yielding a corresponding increase in velocity. Accordingly, the higher explosive loadings and greater depths required for the bonding of thicker cladder components will cause the explosive detonation velocity of any explosive mixture to be increased. With the more conventional higher detonation velocity explosive mixtures detonating above 1800 m/sec., this increased velocity produces a modified waveform containing a greater volume of deleterious intermetallic phases in the wave vortices to further weaken the bond. In the case of the explosive detonating below 1800 m/sec., which is aimed specifically at promoting a waveless interface, the increase in density of the explosive can result in a corresponding and unwanted increase in detonation velocity to a value above 1800 m/sec., which produces waves that negate the objective of using the lower velocity explosive powder.

There are physical means which can be used to avoid an increase in the density of the explosive, such as segregating the explosive into separate layers. However, these means may aggravate the danger of misfires, and can give rise to possible confusion or disorientation of the detonation front, which will have disastrous effects upon the cladding operation.

In certain bonding operations, the practice of using an interlayer is known wherein this interlayer is placed between the cladder layer and the lower substrate layer to either facilitate the bonding of the metal components which are otherwise difficult to bond, or for various other metallurgical requirements. One such requirement is the inclusion of a niobium layer between titanium and steel components to facilitate hot working at temperatures above 850° c., and is the subject of U.S. Pat. No. 6,296,170 B1—Sigmabond Technologies Corporation, issued Oct. 2, 2001. Interlayers of this type are expensive and must be kept to a minimum thickness for commercial viability. This can best be achieved by means of a waveless interface, because waves, if present, can cause total encapsulation, within the wave vortices, of the entire volume of the material making up the thin interlayer, which creates a discontinuous interlayer between the cladder and substrate materials. This discontinuity will compromise the bond in any heating process, and disbanding will occur.

### SUMMARY OF THE INVENTION

The present invention provides a method whereby, notwithstanding the use of explosives detonating above the wavy/waveless transition velocity of 1800 m/sec., waveless interfaces between dissimilar metals are created. This avoids the formation of debilitating intermetallics at the interface and also avoids the creation of shear stresses at the interface. These shear stresses are normally focused at the wave crests and are associated with metal flow during wave formation and shear stresses arising in the immediate post bonding period, as a result of a differential in the rate and amount of elastic recovery of the differing metals. The waveless interfaces are achieved by introducing between the two major components, namely, the cladder and the substrate, an additional interlayer, herein termed “first interlayer” of material of the same or similar composition herein termed “compatible material” as herein after defined, to that of the substrate. This now creates two interfaces, namely, a first interface having a conventional wavy topography between the first interlayer and the substrate of compatible material and a second interface of waveless topography and is a bond between the dissimilar metals of the cladder and first interlayer. This ensures that deleterious intermetallics cannot be formed within the bonded interface of similar metals. The one or more additional overlying interfaces, between dissimilar metals, in accordance with the practice of the present invention are all now of waveless form, as to avoid the formation of any intermetallics and/or the creation of shear cracks.

It is an object of the present invention to provide a method of producing one or more waveless interfaces in a single bonding operation while using explosive mixtures detonating either above or below the arbitrary detonation velocity boundary of 1800 m/sec., which defines the transition between waveless and wavy interface. Consequently, metals that would otherwise form brittle intermetallics at their bonded interface can still be bonded, but that the risk of shear cracks associated with the wavy interface is also avoided.

A further object is to minimize the thickness of any desired interlayer material by producing waveless interfaces at each surface of the interlayer, which minimizes the volume of metal eroded from the interlayer surfaces that would otherwise become encapsulated in any wave vortices, which would otherwise be present.

Accordingly, in one aspect the invention provides a process for the manufacture of an explosively-bonded composite structure comprising a substrate, a metallic cladder and an intervening interlayer between said substrate and said cladder; said process comprising:

(A) forming a non-bonded composite structure comprising in combination,

(a) a substrate having a first side;

(b) an interlayer of a material compatible with said substrate, and having

(i) a thickness T1;

(ii) a mass M1;

(iii) a first side adjacent to said substrate at a distance D1, therefrom; and

(iv) a second side;

(c) a cladder having

(i) a thickness TC;

(ii) a mass MC;

(iii) a first side adjacent to said second side of said interlayer at a distance D2 therefrom; and

(iv) a second side; and

(d) an explosive mixture adjacent said second side of said cladder; and

wherein D1 is equal to or less than 2T1; D2 is equal to or greater than TC; and MC is equal to or greater than M1; and

(B) detonating said explosive mixture.

Preferably, the invention provides said cladder and said interlayer having a waveless interface therebetween.

In a preferred aspect, the invention provides a process as hereinabove defined for the manufacture of an explosively-bonded composite structure comprising a substrate, a cladder and intervening interlayers between said substrate and said cladder; and one second said interlayer and said cladder having a waveless interface therebetween, said process comprising:

(A) forming a non-bonded composite structure comprising in combination,

(a) a substrate having a first side;

(b) a first interlayer of a material compatible with said substrate, and having

(i) a thickness T1;

(ii) a mass M1;

(iii) a first side adjacent to said substrate at a distance D1, therefrom; and

(iv) a second side;

(c) a second interlayer of a material distinct from said first interlayer, and having

(i) a thickness T2;

(ii) a mass M2;

(iii) a first side adjacent said second side of said first interlayer at a distance D3 therefrom; and

(iv) a second side;

(d) a cladder having

(i) a thickness TC;

(ii) a mass MC;

(iii) a first side adjacent to said second side of said second interlayer at a distance D4 therefrom; and

(iv) a second side; and

(e) an explosive mixture adjacent said second side of said cladder; and

wherein D1 is equal to or less than 2T1; D3 is equal to or less than 2T2; D4 is equal to or greater than TC; and MC is equal to or greater than M1+M2; and

(B) detonating said explosive mixture.

Preferably, the first interlayer is the same or of a compatible, similar chemical composition to that of the substrate material. This ensures that any molten material contained in the wave vortices characterizing the first bonded interface is of a composition which is not brittle and does not deleteriously affect the quality of the bond. However, the invention is not so limited as this first interlayer may be of a selected suitable different material which does not form an alloy within the wave vortices which is brittle in character and would so cause the quality of the interface to be disadvantageously affected.

Thus, the term “compatible material” in this specification and claims, is meant the same material as that of the substrate or is so similar in chemical composition as to not form an “alloy” within the wave vortices, which alloy would have brittle intermetallics as to provide a poor quality interface by having shear cracks or adiabatic shear bands, upon bonding or subsequent heating.

Therefore, advantageously, in the practise of the invention, because the surfaces of the first interface are of compatible material as the substrate, and because of the presence of further and overlying bonded interfaces, the formation of shear cracks or adiabatic shear bands is avoided at this first wavy interface.

Further, advantageously, the remaining interfaces other than the first interface between the substrate and the first interlayer, be they bonds between like or dissimilar metals, will be waveless in form. This avoids the formation of wave vortices and the creation of any brittle intermetallics, which may otherwise be formed within such vortices when bonding dissimilar materials.

Yet further, advantageously, the avoidance of waves at these remaining interfaces also eliminates the shear stresses otherwise formed at the crests of such waves. This eliminates or reduces the risk of shear cracks during the bonding operation, or post-bonding in any subsequent fabrication of the clad, or under service conditions.

Further, advantageously, the absence of waves at any interface, other than any at the first interface between the substrate and first interlayer, allows any interlayer which may be included to be minimized in thickness due to the avoidance of wave vortex encapsulation of the interlayer material. This minimizes the volume of metal removed from the interlayer and, at the same time, ensuring continuity of the interlayer material of this minimal thickness.

In one aspect, the invention provides a process as hereinabove defined wherein said cladder and said interlayer has a waveless interface therebetween.

In a further aspect, the invention provides a process as defined wherein each of the bonded interfaces selected from the group consisting of between two adjacent interlayers and an interlayer and cladder is waveless.

Preferably, in the assembly of the component layers prior to bonding, the interfacial gaps, other than the upper interfacial gap between the cladder component and the uppermost interlayer, are kept to a minimum and each gap should not exceed twice the thickness of the individual layer immediately above the gap.

Preferably, the remaining interfacial gap between the cladder component and the upper surface of the uppermost intermediate layer should be of a width which is at least the thickness of the cladder component.

Preferably, the mass of the upper cladder component should be greater than that of the combined mass of the intermediate layers.

In a further aspect, the invention provides a process as hereinabove defined comprising a third interlayer disposed between said second interlayer and said cladder, wherein said third interlayer has

(i) a thickness T3;

(ii) a mass M3;

(iii) a first side adjacent said second side of said second interlayer at a distance of D5;

and a second side adjacent said first side of said cladder at a distance of D6 and wherein

D1 is equal to or less than 2T1

D3 is equal to or less than 2T2

D5 is equal to or less than 2T3

D6 is equal to or greater than TC and

MC is greater than (M1+M2+M3).

Accordingly, in preferred embodiments of the invention as hereinabove defined:

D2 is selected from 1.0-6.0 TC;

D3 is selected from 0.1-2.0 T2, more preferably 1.0-2.0 T2; and yet more preferably 1.0-1.5 T2;

D4 is selected from 1.0-6.0 TC, and more preferably 1.0-3.0 TC;

D5 is selected from 0.1-2.0 T3, and more preferably 1.0-2.0 T3;

D6 is selected from 1.0-6.0 TC, and more preferably 1.0-3.0 TC;

MC is (i) preferably greater than M1, and more preferably greater than 1.5 M1 or (ii) preferably greater than (M1+M2), and more preferably greater than 1.5 (M1+M2) or (iii) preferably greater than 1.0 (M1+M2+M3) and more preferably greater than 1.5 (M1+M2+M3).

Accordingly, the invention in a further aspect provides a process as hereinabove defined wherein said second interlayer is constituted as a plurality of second interlayers having a combined mass of M4 and disposed one adjacent another at a second interlayer distance selected from DX, DY, DZ . . . , which may be the same or different; and wherein

(i) each of said interlayers has a thickness selected from TX or TY or TZ or . . . , which may be the same or different;

(ii) each of said interlayer distances DX DY DZ . . . is equal to or less than twice the thickness of any adjacent second interlayer; and

(iii) MC is greater than M1+M4.

Preferably DX, DY, DZ is selected from 0.1-2.0 (TX or TY or TZ or . . . ), and more preferably selected from 1.0-2.0 (TX or TY or TZ or . . . ); and

MC is greater than 2.0 (M1+M4).

Typical distances between the interlayers and between an interlayer and the substrate are selected from about 1 to about 5 mm, preferably, about 1.5 mm. Typically, the cladder-interface distance is selected from about 10-15 mm, preferably, about 12 mm.

The invention is of particular value where the substrate is formed of a low carbon or stainless steel having a titanium, zirconium, or alloy thereof cladder layer and a copper, niobium, tantalum or vanadium second interlayer.

Preferably, the compatible material is identical to the substrate material.

The explosive mixture may have a velocity selected from at least 1800 m/s or less than 1800 m/s, but preferably greater than 1000 m/s and less than 100% of the sonic velocity of the cladder metal.

In a further aspect, the invention provides an explosively bonded composite structure made according to a process as hereinabove defined.

Without being bound by theory, we believe that an explanation for being able to produce a desired explosively bonded composite structure according to the invention is associated, inter alia, with the timing of the application of collision forces of the initially non-bonded components, as now further described.

Unlike the ultimate collision of the interlayer with the substrate, the bonding of the cladder to the interlayer does not occur at the moment of their initial contact with each other, but subsequently upon the collision of the interlayer with the high mass substrate at the lower interface. It is at this precise moment that the inertia of the high mass substrate causes the kinetic energy of the impelled plates to be dissipated and the collision pressure to be generated at each of the interfaces concomitantly, and consequently, bonding at all interfaces occurs simultaneously. This reasoning is supported by the evidence when cladding in a contrary manner with thick interlayers, where the increased mass of the interlayer gives it sufficient inertia for bonding to occur on the initial contact of cladder and interlayer, waves then appear also on the upper interface. This is so because bonding is now occurring at each interface independently and consecutively and at the moment of contact of the interfacial surfaces. From these observations, it is clear that in the form of bonding in which one or more interlayers are used, there is a significant relationship between the mass of any cladder component and the mass of interlayer(s) used in conjunction with that cladder.

We have also found that, preferably, the interfacial gaps between the components are also important, as it is essential, when bonding and utilizing thin interlayers, that the collision pressure generated at all interfaces upon the ultimate contact of the lower interlayer and the base, is generated as soon as possible after the initial collision of these upper surfaces. That is, the interval of time between the initial contact of the interfacial surfaces and the moment when collision pressure is ultimately generated at those surfaces must be minimized. Consequently, the gaps between each of the interlayers and between the lowermost interlayer and the substrate must be small. However and conversely, the gap between the uppermost high mass component (the cladder) and the uppermost interlayer must be sufficiently large to give an adequate interval of time for the cladder to be accelerated by the explosive, thereby allowing the velocity and kinetic energy of the cladder to increase to an adequate level for generation of the required collision pressure at each of the interfaces.

Accordingly, preferably, it is required that in such bonding operations, the interfacial gaps between the one or more interlayers and the lowermost gap between interlayer and substrate should be of a dimension less than twice the interlayer thickness.

It is also preferred that the upper interfacial gap between the lower surface of the cladder and the upper surface of the immediately adjacent interlayer should be at least the thickness of the cladder component and preferably greater than 1.5 times the thickness of the cladder component.

### BRIEF DESCRIPTION OF THE DRAWINGS

In order that the invention may be better understood, preferred embodiments will now be described by way of example only, with reference to the accompanying drawings, wherein:

FIG. 1 is a schematic representation of a conventional method for the manufacture of an explosive bonded composite structure consisting of a single cladder material, bonded to a single component substrate of a different material according to the prior art;

FIG. 2 shows, schematically, the nature of the resultant bonded wavy interface between the cladder and substrate materials of the resulting composite structure of FIG. 1;

FIG. 3 shows a schematic presentation of a set-up of one embodiment method of the present invention for the production of a bonded composite clad between two materials and incorporating a bonded composite substrate component of a single material but producing a non-wavy interface between different cladder and substrate materials;

FIG. 4 shows a schematic representation of the two interfaces contained in the bonded composite structure of FIG. 3;

FIG. 5 shows a schematic representation of an alternative embodiment of a method of the invention, which incorporates an interlayer material differing from that of the cladder and substrate materials and which is bonded to the cladder component and a bonded composite substrate component comprised of a single type of material;

FIG. 6 shows, schematically, the three bonded interfaces contained in the bonded composite structure of FIG. 5;

FIG. 7 is a repeat sketch of FIG. 5 wherein the components, thickness and gaps of the non-bonded composite structure are formed in combination prior to detonation of the explosive and are differently identified.

FIG. 8 is a non-bonded composite structure prior to detonation similar to that shown in FIG. 7, but wherein the second interlayer is constituted as a plurality of individual second interlayers;

and wherein the same numerals denote like parts.

### DETAILED DESCRIPTION OF PREFERRED EMBODIMENTS

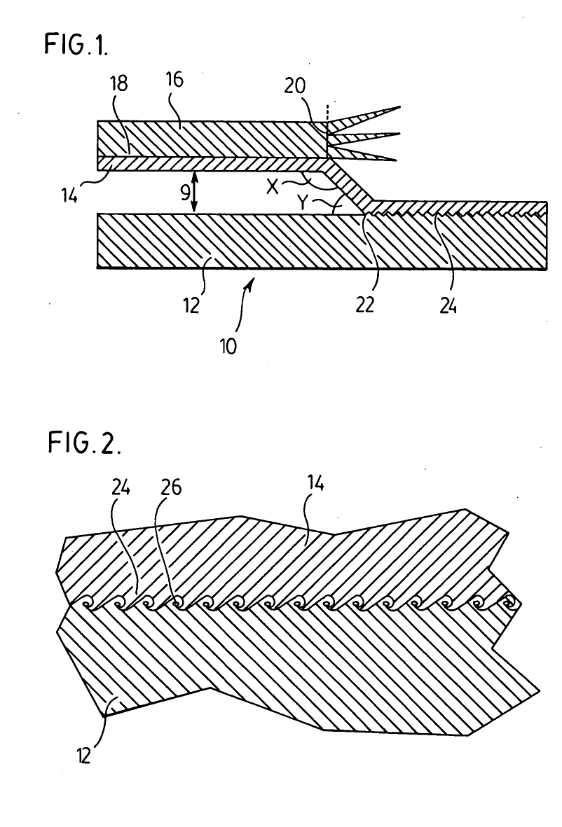

FIG. 1 shows generally as 10 a schematic representation of a conventional explosive bonding arrangement during the process of bonding and wherein a substrate metal (12), herein a low carbon steel, has a cladder component (14), herein of titanium, placed above and separated from substrate (12). An explosive powder mixture (16) having a velocity of greater than 1800 m/s is located upon upper surface (18) of cladder (14). Upon ignition of explosive (16), a detonation front (20) passes through explosive (16) and causes cladder (14) to be deformed downwards through an angle “X” over and through the gap “g”, known as the “dynamic angle”, with cladder (14) traveling between substrate (12) and cladder (14) to collide with substrate (12) at an angle “Y”, known as the “collision angle”. The pressure generated at the point of collision (22) causes the component surfaces to behave as inviscid fluids, whereby a wavy bond (24) is formed behind the collision point (22).

FIG. 2 shows a schematic representation of the appearance of the type of bond formed using the method described hereinabove with reference to FIG. 1. The bond between substrate (12) and cladder (14) is characterized by waves (24) with associated vortices (26), which contain an alloy of materials (12, 14). The alloy may be brittle in form and which results in the bond being substantially weakened.

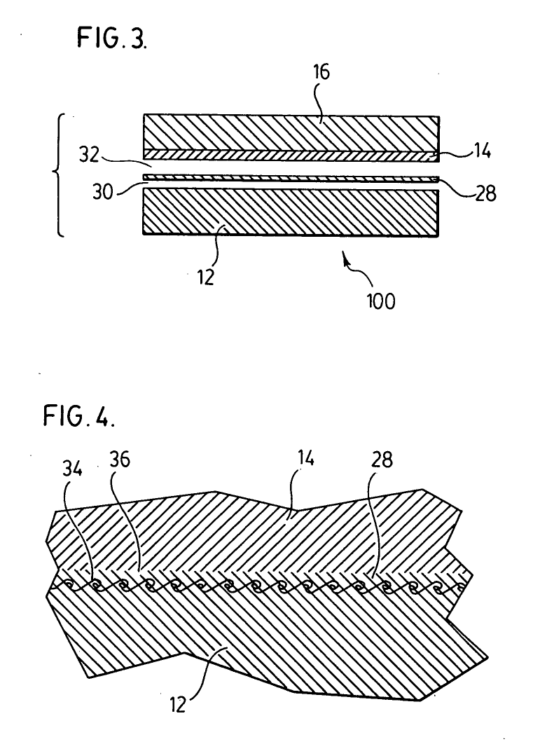

FIG. 3 illustrates, generally as 100, the set-up arrangement of a first method of bonding according to the present invention and consists of steel substrate component (12) over which is placed titanium cladder component (14) having on its' upper surface a layer of explosive (16). Between substrate (12) and cladder (14) there is interposed an interlayer (28) of a thin intermediate sheet of material which, preferably, is of identical material herein low carbon steel to that of substrate (12). Material (28) should be selected to ensure that any melting together of substrate (12) and sheet (28) materials does not constitute a brittle intermetallic substance. A first and lower gap (30) is arranged between substrate (12) and interlayer (28) of a distance which preferably should not exceed twice the thickness of interlayer (28). A second or upper gap (32) is arranged between interlayer 28 and the underside of cladder (14), which, preferably, should be of a width not less than the thickness of cladder (14). The mass of cladder (14) should, preferably, be a minimum of 1.5 times the mass of interlayer (28). Upon initiation of explosive (16), the three components (12), (28) and (14) are bonded together, concomitantly.

FIG. 4 shows the topography of the two bonded interfaces (34) and (36) of the composite structure shown generally as 200 formed by the method described with reference to FIG. 3. The lower bonded interface (34) between substrate (12) and interlayer (28) is of wavy form, but contains no brittle intermetallics because the materials of substrate (12) and interlayer (28) are identical as to ensure that any molten metal formed between them, which is encapsulated in the wave vortices, will not be of brittle form. Thus, lower bond interface (34) is sound in quality, albeit wavy in form. The second and upper bond (36) between interlayer (28) and cladder (14), notwithstanding they are dissimilar materials, is devoid of waves. This ensures the absence of any wave vortices and any deleterious brittle intermetallic, which could otherwise be formed in such vortices. The absence of waves in upper bond (34) also eliminates any inherent and damaging shear stresses which are normally focused at the crests of waves, when present, and which are associated with the turbulent flow of metal as the waves are formed, and also because of differential rates and values of elastic recovery which occur immediately post bonding between certain differing materials.

The embodiment shown with reference to FIG. 3 and FIG. 4 results by reason of judicious selection of the relative mass of each component and inter component distances according to the invention.

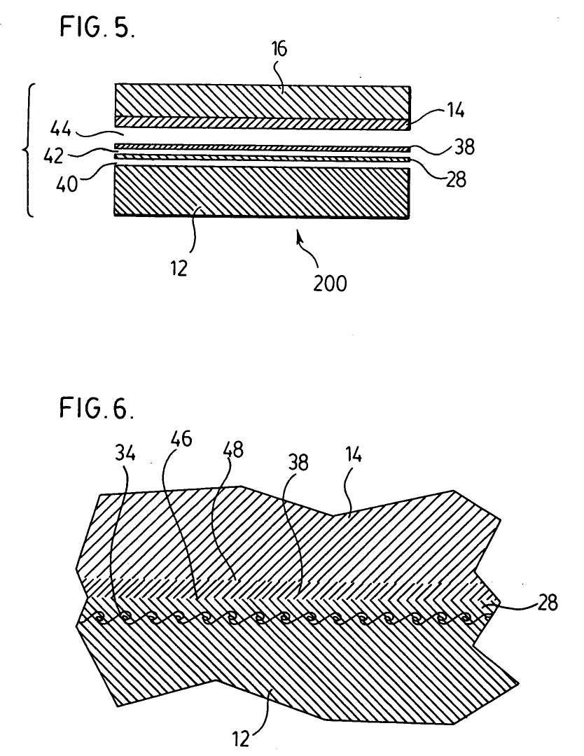

FIG. 5 illustrates generally as 200, an alternative arrangement of components of use in a method of bonding according to the present invention and shows steel substrate component (12) over which is placed titanium cladder component (14) having on its upper surface a layer of explosive (16). Between substrate (12) and cladder (14) is interposed steel first interlayer (28), and above which is a second interlayer component sheet (38) of material selected for its appropriate metallurgical properties. Second interlayer (38) is niobium in this embodiment. A first and lower interfacial gap (40) separates substrate (12) from the underside of first interlayer (28), which gap is of a width not exceeding twice the thickness of interlayer (28). A second gap (42) exists between lower interlayer (28) and second interlayer component (38), which is of a dimension not exceeding twice the thickness of second interlayer component (38). A third and upper gap (44), exists between the second interlayer component (38) and cladder (14) and the width of this gap should not be less than the thickness of cladder (14). The mass of cladder (14) is at least twice that of the combined mass of first interlayer (28) and second interlayer (38). Upon initiation of explosive layer (16), components (12), (28), (38) and cladder (14) are bonded together, concomitantly.

FIG. 6 shows, schematically, the topography of the three bonded interfaces (34), (46) and (48) of the composite structure manufactured by the method described hereinabove with reference to FIG. 5. Lower bonded interface (34) between substrate (12) and first interlayer (28) is of wavy form and contains no brittle intermetallics because the materials of substrate (12) and first interlayer (28) are either identical, similar, or are otherwise selected to ensure that any alloy formed between them which is encapsulated in the wave vortices will not be of brittle form. Thus, lower bonded interface (34) is sound in quality, albeit wavy in form. Bonded interfaces (46) and (48), which exist on both sides of second interface layer (38), are waveless in form and, thus, avoid the turbulent metal flow involved in the formation of such waves. This ensures that a minimum amount of metal is removed from the thickness of second interlayer (38) and, thereby, allowing the thickness of second interlayer (38) to be minimized while still ensuring that interlayer (38) remains as a continuous layer, which separates the material of first interlayer (28) and the overlying cladder (14).

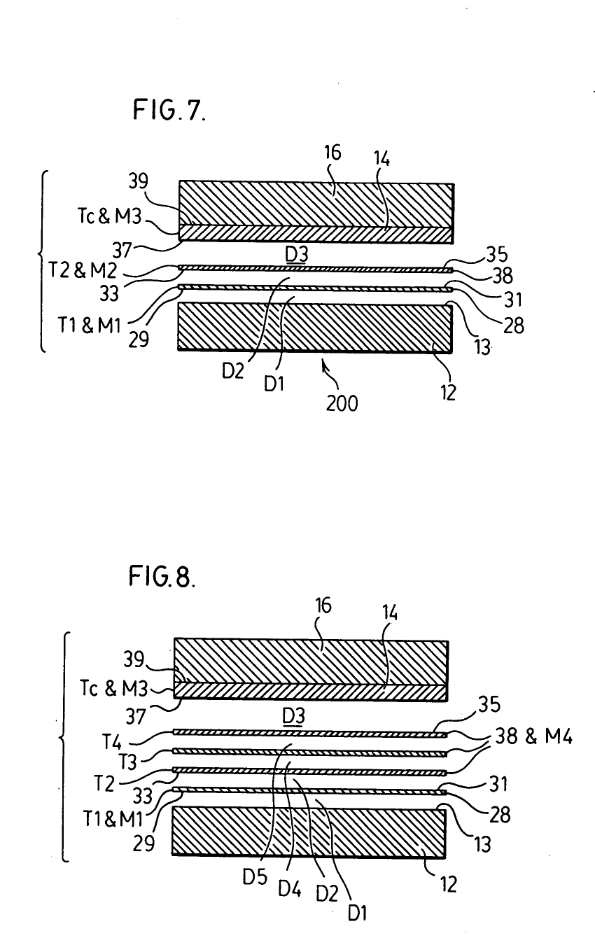

FIG. 7 is a repeat sketch of FIG. 5 wherein the components, thickness and gaps of the non-bonded composite structure 200 are formed in combination prior to detonation of the explosive and are differently identified.

Thus, FIG. 7 illustrates a process for the manufacture of an explosively-bonded composite structure (200) comprising substrate (12), cladder (14) and intervening interlayers (28, 38) between substrate (12) and cladder (14); wherein cladder (14) and interlayer (38) have a waveless interface therebetween, interlayer (38) and interlayer (28) have a waveless interface therebetween, and interlayer (28) and substrate (12) have a wavy interface therebetween. The process comprises:

(A) forming a non-bonded composite structure comprising in combination,

(a) substrate (12) having a first side (13);

(b) first interlayer (28) of a material compatible with substrate (12), and having

(i) a thickness T₁; (ii) a mass M₁; (iii) a first side (29) adjacent to substrate (12) at a distance D₁, therefrom; and (iv) a second side (31);

(c) a second interlayer (38) of a material distinct from first interlayer (28), and having

(i) a thickness T₂; (ii) a mass M₂; (iii) a first side (33) adjacent second side (31) of first interlayer (28) at a distance D₂ therefrom; and (iv) second side (35);

(d) cladder (14) having

(i) a thickness T_{C}; (ii) a mass M₃; (iii) a first side (37) adjacent to second side (35) of second interlayer (38) at a distance D₃ therefrom; and (iv) a second side (39); and

(e) an explosive mixture (16) adjacent second side (39) of cladder (14); and

wherein D₁ is equal to or less than 2T₁; D₂ is equal to or less than 2T₂; D₃ is equal to or greater than T_{C}; and M₃ is equal to or greater than M₁+M₂; and

(B) detonating explosive mixture (16).

FIG. 8 is a non-bonded composite structure prior to detonation similar to that shown in FIG. 7, but wherein second interlayer (38) is constituted as a plurality of individual second interlayers (38), which in this embodiment, is represented as three second interlayers (38). The individual second interlayers (38) have a combined mass of M₄, an individual thickness selected from T₂, T₃, T₄ and second interlayer distances selected from D₂, D₄ and D₅.

Thus, FIG. 8 illustrates a process as described under FIG. 7 wherein second interlayer (38) is constituted as a plurality of second interlayers (38) having a combined mass of M₄ and disposed one adjacent another at a second interlayer distance selected from D₂, D₄, D₅, D₆ . . . , which may be the same or different; and (i) wherein each of interlayers (38) has a thickness selected from T₁ T₂, T₃, T₄ . . . , which may be the same or different; (ii) each of interlayer distances D₂, D₄; D₅; D₆ . . . is less than twice the thickness of any adjacent second interlayer; and

(iii) M₃ is equal to or greater than M₁+M₄.

Thus, D₃ is the distance between cladder surface 37 and surface 35 of the specific second interlayer (38) of the plurality of interlayers (38) adjacent to surface (37). Analogously, D₂ is the distance between first interlayer surface (31) and surface (33) of the specific second interlayer (38) of the plurality of interlayers (38) adjacent to surface (31).

With general reference to the aforesaid Figures, preferred embodiments are further described with reference to the following examples which provide further specific guidance in the performance and understanding of the invention.

### EXAMPLES

In the following examples, the mass ratios are defined on the basis of mass per unit area (gm/cm²) and not the actual masses of the cladder and interlayers total weight. This is because the set up of the pre-bonded composite components demands that the area of the cladder exceeds that of the areas of the other components, i.e. substrate and interlayers, to give a cladder area and explosive area which overhangs the edges of the substrate and interlayers. This arrangement reduces or eliminates the non bonds which can occur at the sample edges due to the fall off in explosive pressure in these areas which would otherwise occur if all the component areas were identical.

### Example 1

A cladding arrangement was set-up by the method of the present invention and used to bond a 6 mm thick titanium cladder at a cladder mass of 2.71 gm/cm² to a low carbon steel substrate and incorporating a 1 mm thick copper interlayer, herein a first interlayer, at an interlayer mass of 0.896 gm/cm² to provide a cladder:interlayer mass ratio of 3.02:1. This sample had dimensions of 600 mm×350 mm area and was produced as a control to be compared with subsequent clads, which incorporated a second interlayer of a more expensive material and made by the method of the present invention. The lower gap between the copper and steel was 1.5 mm and the upper gap between the copper interlayer and titanium cladder was 12 mm. The explosive had a depth of 11 cm and a detonation velocity of 1850 m/sec.

The resulting bonded composite structure was sectioned along its 600 mm length to reveal a continuous bond from front to rear of the clad with waves at the lower interface between the copper and steel and a flat interface at the upper interface between the copper and titanium. The wave amplitude was approximately 0.25 mm in height and, as a result, the copper thickness varied between 0.75 mm and 1.25 mm.

### Example 2

A set up identical to that described under Example 1 was arranged for the production of a second composite structure but now fabricated by the method of the invention by interposing an additional 1 mm thick intermediate layer of low carbon steel (herein “the first interlayer”) having an interlayer mass of 0.79 gm/cm² between the copper interlayer, herein the second interlayer, and the first interlayer of steel, to provide a cladder:combined interlayers mass ratio of 1.61:1. The gap between the first steel interlayer and the steel substrate was 1.5 mm. The gap between the first steel and second copper interlayers was also 1.5 mm, and the upper gap between cladder and the copper interlayer was 12 mm. Identical explosive from the same batch at a depth of 13 cm to accommodate the greater composite mass of the layers being bonded was used to form the composite structure.

The resulting clad was again sectioned along its 600 mm length to reveal continuous bonds along the length of the three bonded interfaces. The two uppermost bonds on both sides of the copper interlayer were flat to give a continuous layer of copper of a uniform thickness of 1 mm. A wavy interface existed at the lower interface between the steel substrate and the steel interlayer.

### Example 3

Two identical clads were set up to practice a method according to the method of the present invention in which 6 mm thick titanium cladders were to be bonded to steel substrates. A 1 mm thick niobium interlayer of 0.857 gm/cm² mass was also incorporated. The clad sample of 600 mm×350 mm area was set up using a low carbon steel substrate, above which was placed a 1 mm thick low carbon steel interlayer having an interlayer mass of 0.79 gm/cm² (herein “a first interlayer”), and between the two was an interfacial gap of 1.5 mm. The 1 mm niobium interlayer (herein “a second interlayer”) was disposed above the steel first interlayer. The interfacial gap between the niobium and steel interlayer also being 1.5 mm. Above this assembly was placed the 6 mm titanium cladder of mass 2.71 gm/cm², with an interfacial gap between the titanium and niobium of 12 mm, to provide a cladder:combined interlayers mass ratio of 1.64:1. An explosive layer of 13 cm depth covered the upper surface of the cladder, which propagated at a velocity of 1900 m/sec.

One of the resulting samples was not sectioned, but polished along its long edge to reveal a uniform 1 mm thickness of niobium interlayer with no waves on the interfaces either side of the niobium interlayer. A wavy interface existed at the lower interface between the steel interlayer and steel substrate. Both samples were subjected to shear tests to give values of 45,000 and 38,000 psi. Samples of these same clads were also heat treated for several hours at a temperature of 1250° C. Shear tests after this heat treatment gave values of 27,000 and 28,000 psi. The residual area of the two samples, which formed the bulk of the area originally clad, were then successfully hot rolled at a temperature of 1,100° C.

Although this disclosure has described and illustrated certain preferred embodiments of the invention, it is to be understood that the invention is not restricted to those particular embodiments. Rather, the invention includes all embodiments, which are functional or mechanical equivalence of the specific embodiments and features that have been described and illustrated.

1. A process for the manufacture of an explosively-bonded composite metallic structure comprising a substrate, a cladder and an intervening interlayer between said substrate and said cladder; said process comprising:
(A) forming a non-bonded composite structure comprising in combination,
(a) a substrate having a first side;
(b) an interlayer of a material compatible with said substrate, and having
(i) a thickness T1;
(ii) a mass M1;
(iii) a first side adjacent to said substrate at a distance D1 therefrom; and
(iv) a second side;
(c) a cladder having
(i) a thickness TC;
(ii) a mass MC;
(iii) a first side adjacent to said second side of said interlayer at a distance D2 therefrom; and
(iv) a second side; and
(d) an explosive mixture adjacent said second side of said cladder; and
wherein D1 is equal to or less than 2T1; D2 is equal to or greater than TC; and MC is equal to or greater than M1; and
(B) detonating said explosive mixture.

2. A process as defined in claim 1 for the manufacture of an explosively-bonded composite structure comprising a substrate, a cladder and intervening interlayers between said substrate and said cladder; said process comprising:
(A) forming a non-bonded composite structure comprising in combination,
(a) a substrate having a first side;
(b) a first interlayer of a material compatible with said substrate, and having
(i) a thickness T1;
(ii) a mass M1;
(iii) a first side adjacent to said substrate at a distance D1, therefrom; and
(iv) a second side;
(c) a second interlayer of a material distinct from said first interlayer, and having
(i) a thickness T2;
(ii) a mass M2;
(iii) a first side adjacent said second side of said first interlayer at a distance D3 therefrom; and
(iv) a second side;
(d) a cladder having
(i) a thickness TC;
(ii) a mass MC;
(iii) a first side adjacent to said second side of said second interlayer at a distance D4 therefrom; and
(iv) a second side; and
(e) an explosive mixture adjacent said second side of said cladder; and
wherein D₁ is equal to or less than 2T1; D3 is equal to or less than 2T2; D4 is equal to or greater than TC; and MC is equal to or greater than M1+M2; and
(B) detonating said explosive mixture.

3. A process as defined in claim 2 further comprising a third interlayer disposed between said second interlayer and said cladder, wherein said third interlayer has
(i) a thickness T3;
(ii) a mass M3;
(iii) a first side adjacent said second side of said second interlayer at a distance of D5;
and a second side adjacent said first side of said cladder at a distance of D6 and wherein
D1 is equal to or less than 2T1
D3 is equal to or less than 2T2
D5 is equal to or less than 2T3
D6 is equal to or greater than TC and
MC is equal to or greater than (M1+M2+M3).

4. A process as defined in claim 2 wherein said second interlayer is constituted as a plurality of second interlayers having a combined mass of M4 and disposed one adjacent another at a second interlayer distance selected from DX, DY, DZ . . . , which may be the same or different; and wherein
(i) each of said interlayers has a thickness selected from TX or TY or TZ or . . . , which may be the same or different;
(ii) each of said interlayer distances DX DY DZ . . . is equal to or less than twice the thickness of any adjacent second interlayer; and
(iii) MC is equal to or greater than M1+M4.

5. A process as defined in claim 1 wherein D2 is selected from 1.0-6.0 TC; and
MC is greater than M1.

6. A process as defined in claim 1 wherein
D2 is selected from 1.0-3.0 TC; and
MC is greater than 1.5 M1.

7. A process as defined in claim 2 wherein
D3 is selected from 0.1-2.0 T2;
D4 is selected from 1.0-6.0 TC; and
MC is greater than (M1+M2).

8. A process as defined in claim 7 wherein
D3 is selected from 1.0-2.0 T2; and
D4 is selected from 1.0-3.0 TC.

9. A process as defined in claim 8 wherein
D3 is selected from 1.0-1.5 T2;
D4 is selected from 1.0-1.5 TC; and
MC is greater than 1.5 (M1+M2).

10. A process as defined in claim 3 wherein
D3 is selected from 0.1-2.0 T2;
D5 is selected from 0.1-2.0 T3;
D6 is selected from 1.0-6.0 TC; and
MC is greater than (M1+M2+M3).

11. A process as defined in claim 10 wherein
D3 is selected from 1.0-2.0 T2;
D5 is selected from 1.0-2.0 T3;
D6 is selected from 1.0-3.0 TC; and
MC is greater than 1.5 (M1+M2+M3).

12. A process as defined in claim 11 wherein
D3 is selected from 1.0-1.5 T2;
D5 is selected from 1.0-1.5 T3; and
D6 is selected from 1.0-1.5 TC.

13. A process as defined in claim 4 wherein any one of DX, DY, DZ is selected from 0.1-2.0 (TX or TY or TZ) and MC is greater than (M1+M4).

14. A process as defined in claim 13 wherein any one of DX, DY, DZ is selected from 1.0-2.0 TX or TY or TZ and MC is greater than 1.5 (M1+M4).

15. A process as defined in claim 4 wherein any one of DX, DY, DZ is selected from 1.0-1.5 TX, or TY, or TZ and MC is greater than 1.5 (M1+M4).

16. A process as defined in claim 1 wherein said compatible material is identical to the substrate material.

17. A process as defined in claim 1 wherein said explosive mixture has a velocity of at least 1800 m/s.

18. A process as defined in claim 1 wherein said explosive mixture has a velocity of less than 1800 m/s.

19. A process as defined in claim 1 wherein said explosive mixture has a detonation velocity greater than 1000 m/s and less than 100% of the sonic velocity of said cladder metal.

20. A process as defined in claim 1 wherein said cladder is selected from titanium, zirconium, or an alloy, thereof.

21. A process as defined in claim 1 wherein said first interlayer is selected from the group consisting of a low carbon or stainless steel.

22. A process as defined in claim 1 wherein said second interlayer is selected from the group consisting of copper, niobium, tantalum and vanadium.

23. A process as defined in claim 1 wherein said interlayer and said substrate have a wavy interface therebetween.

24. A process as defined in claim 1 wherein said cladder and said interlayer has a waveless interface therebetween.

25. A process as defined in claim 1 wherein each of the bonded interfaces selected from the group consisting of between two adjacent interlayers and an interlayer and cladder is waveless.

26. An explosively bonded composite structure made according to a process as defined in claim 1.
